(19) United States
(12) Patent Application Publication
(10) Pub. No.: US 2017/0095107 A1
(43) Pub. Date: Apr. 6, 2017

(54) DRIP PORTABLE CUP

(71) Applicant: Jen-Hui Chen, Taipei (TW)

(72) Inventor: Jen-Hui Chen, Taipei (TW)

(21) Appl. No.: 14/873,161

(22) Filed: Oct. 1, 2015

(51) Int. Cl. A47J 31/10; A47J 31/00

(52) U.S. Cl. CPC A47J 31/10; A47J 31/005

(57) ABSTRACT

A drip portable cup comprises a cup container, a drip container, a cover body and a filter container. The cup container is screwed on the lower part of the drip container, the filter container is located between the drip container and cup container, the cover body is screwed on the upper part of drip container, and there is a drip part in the drip container. Therefore, the drip part and filter container filter the coffee, and the cup container holds the coffee dripped from the filter container, so that the user can enjoy coffee everywhere at any time.

### BACKGROUND OF INVENTION

1. Field of the Invention

The present invention relates to a drip portable cup.

2. Description of Related Art

There are about three ways to make coffee at home, instant, drip and cooking. The present invention improves the device for drip coffee. The drip coffee is an option between coffee machine and instant coffee. The ground coffee is put in the funnel-shaped filter paper, the boiling water is poured in the filter paper to obtain thick, pure and fragrant coffee.

The device for traditional drip coffee is “coffee making stand”, which has the defects of large volume and restricted occasion, so the usage degree of freedom is low. Therefore, it is impossible to drink coffee at any time in work, open air or travel.

In addition, there is a “structure of drip cup”, which is small and portable, but it has the following problems: the components are assembled by chucking, if the binding site is not tight or steady enough, it is likely to leak and to be disassembled when it is shaken by external force or tilted.

Thus, to overcome the aforementioned problems of the prior art, it would be an advancement in the art to provide an improved structure that can significantly improve the efficacy.

### SUMMARY OF THE INVENTION

the present invention is a drip portable cup, the portable cup comprising: a cup container having the first thread on top outer wall; a drip container disposed at a top of the cup container and comprising a funnel-shaped bottom wall, a casing wall surrounding the bottom wall, a connection wall extending downwards from the bottom edge of the casing wall, a plurality of flanges surrounded at a bottom surface of the bottom wall a ring groove arranged between the flange and the casing wall, a drip part disposed in a center of the bottom wall for dripping water, a second thread surrounded in the top outer wall of the casing wall, and a third thread arranged in the inner wall of the connection wall corresponding to the first thread and screwed on the first thread, so that the drip container can be screwed on the cup container;

a cover body at the top of the drip container, and the bottom inner wall of the cover body corresponds to the second thread, surrounded with the fourth thread which can be screwed on the second thread, so that the cover body can be screwed on the drip container; and a filter container disposed between the drip container and the cup container; the top edge of the filter container is clamped in the ring groove of the drip container; the top outer wall of the filter container is surrounded with a bearing rib which can be gripped by the inner wall of the cup container; a fitter screen at the bottom of the filter container.

wherein the drip part comprises a projection in the center of the bottom wall; a ring wall around the projection; a water holding space between the ring wall and the projection; a projecting part on the top of the projection; a water inlet through the center of the projecting part for dripping the water from the water holding space (263) into the filter container; and a through hole with narrow top and wide bottom which is connected to the bottom of the water inlet.

Wherein the top of the cover body has a concave annular groove, there is a drainage hole in the front of the annular groove, and there is a close over in the annular groove which can pivot to open or close the drainage hole.

Wherein the fourth thread of the cover body can be screwed on the first thread of the cup container, so that the cover body can be screwed on the cup container.

Wherein a seizing part on the inner wall of the bottom edge of the filter container, the filter screen comprises a silica gel cover gripping the seizing part and a screen at the bottom of the silica gel cover.

The function and effect of the present invention are described below:
1: the drip part is combined with the filter container, when the water drips from the drip part to the pulverized coffee in the filter container continuously, the pulverized coffee absorbs the water and swells, when it is saturated, it drips through the filter screen at the bottom of the filter container into the cup container for the user to drink, so as to implement dripping.
2: the cover body can be loosened and removed from the drip container, combined with the cup container for thermal insulation and cold insulation. Therefore, the present invention can be combined into different forms.
3: the user can take the portable cup with him when traveling or working outdoors, and he can make coffee at any time without coffee machine, it is very convenient.
4: the cup container, drip container and cover body are screwed, so the tightness and firmness are better than traditional cup, avoiding water leak and structural disassembly when it is shaken by external force or tilted. In addition, it is convenient to be assembled and disassembled. To clean the portable cup, the structures are loosened disassembled one by one, and cleaned one by one, so as to avoid leaving stains on the portable cup.
5: the filter container is set between the drip container and the cup container, so the drip container and the cup container are loosened and disassembled before the filter container is taken out and cleaned.

### BRIEF DESCRIPTION OF THE DRAWINGS

FIG. 1: Three-dimensional schematic of the present invention.

FIG. 2: Exploded schematic of the present invention.

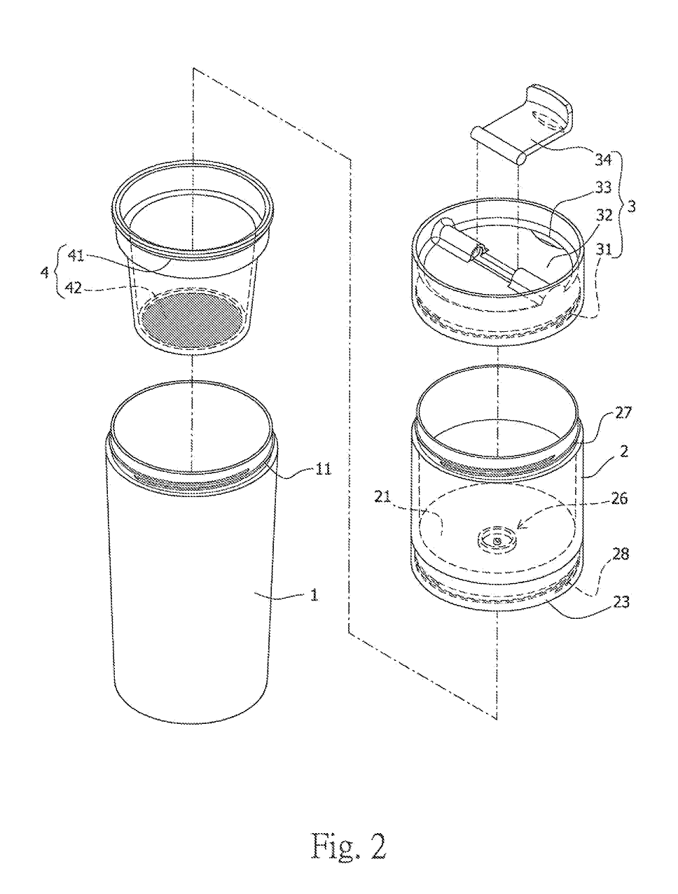

FIG. 3: P-P schematic section of the present invention.

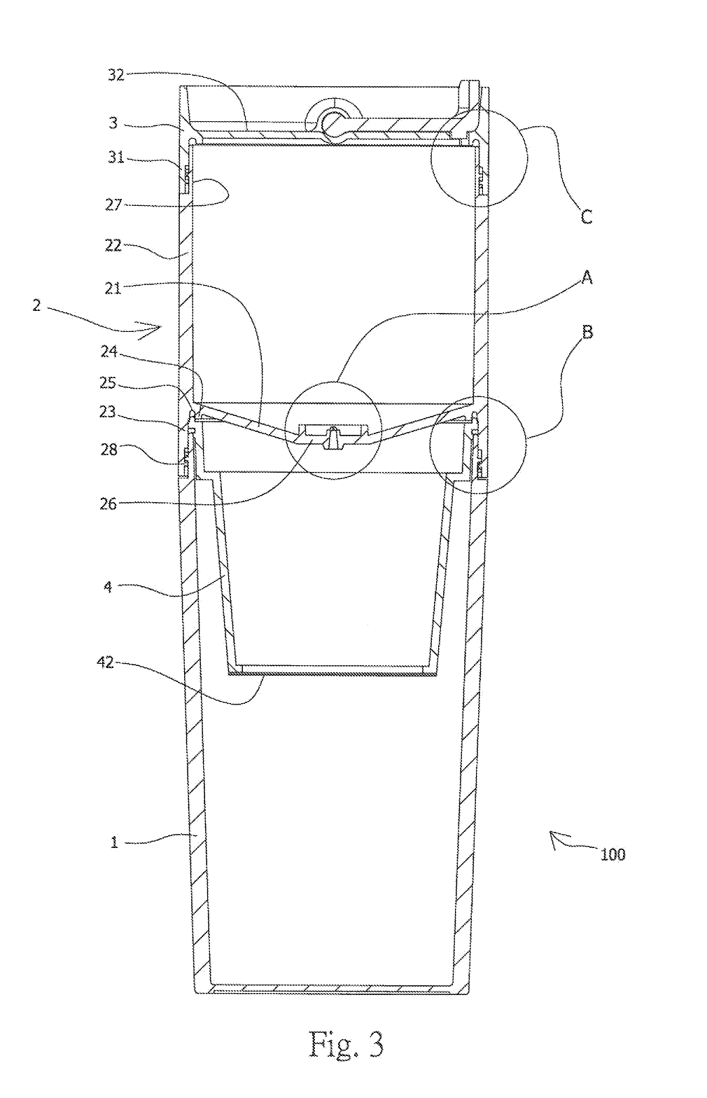

FIG. 4: schematic section of Part A of FIG. 3.

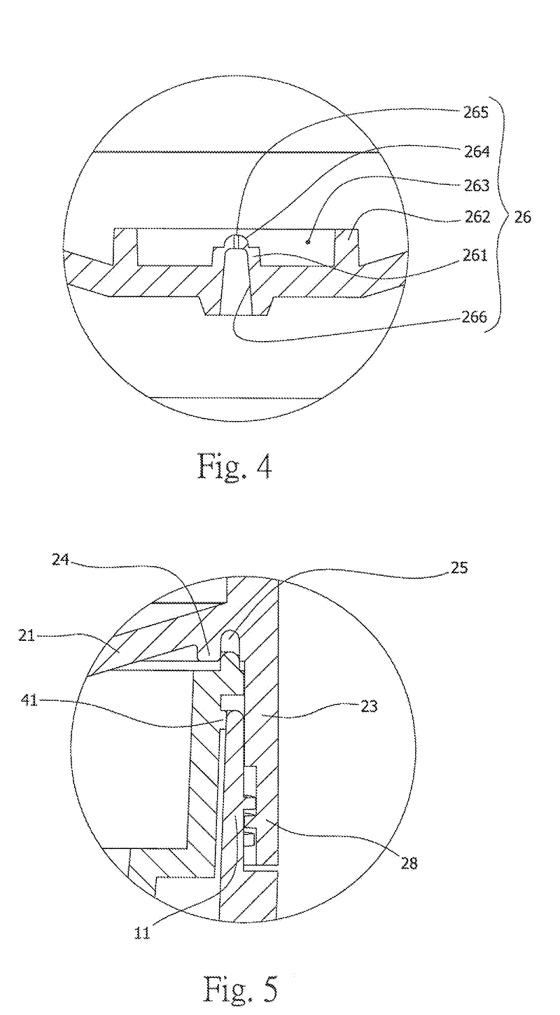

FIG. 5: schematic section of Part B of FIG. 3.

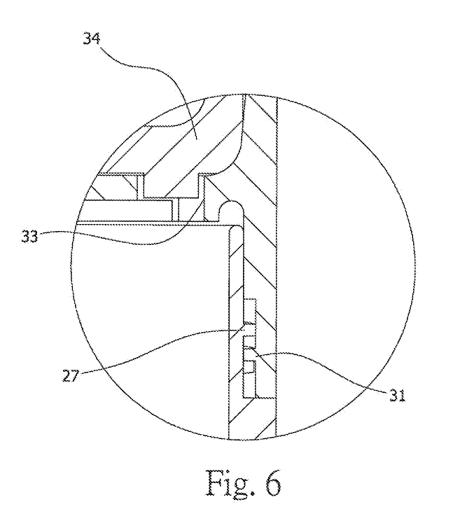

FIG. 6: schematic section of Part C of FIG. 3.

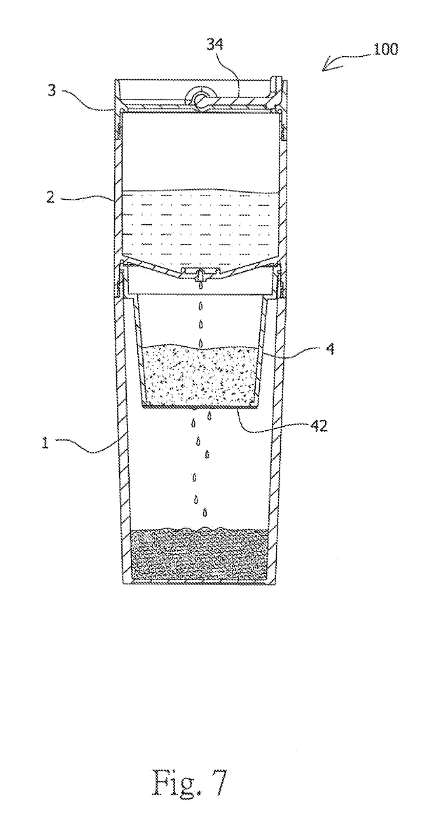

FIG. 7: schematic implementation of the present invention.

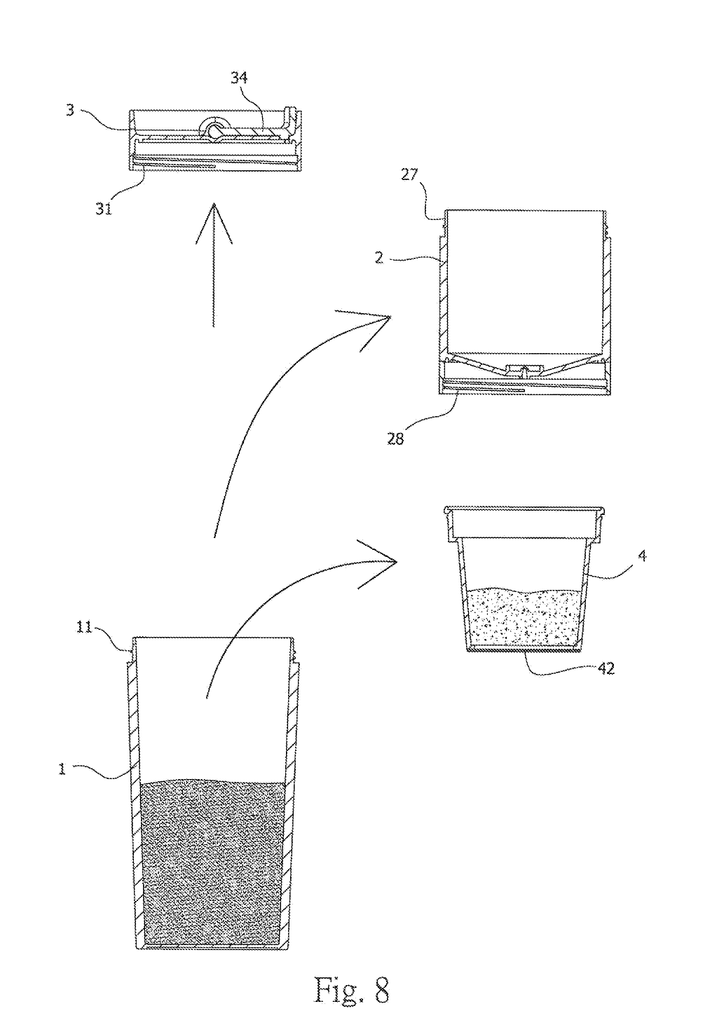

FIG. 8, 9: schematic implementation of the present invention changed into thermal insulation and cold insulation cups.

FIG. 10: schematic section of another implementation form of the filter container of the present invention.

### DETAILED DESCRIPTION OF THE INVENTION

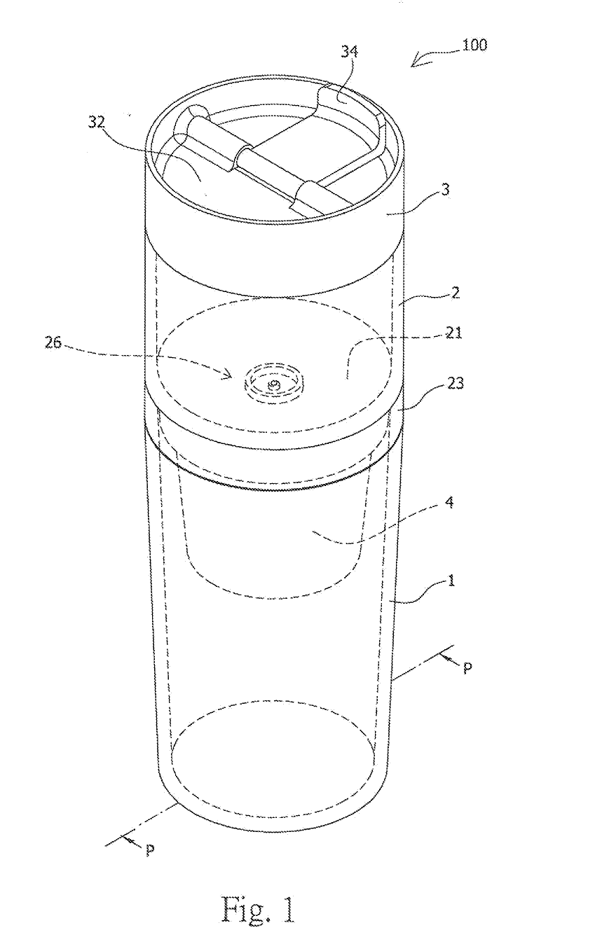

FIGS. 1˜7 disclose a drip portable cup (100), including a cup container (1), the top outer wall has the first thread (11); a drip container (2), at the top of the cup container (1), and the drip container (2) comprises a funnel-shaped bottom wall (21), a casing wall (22) surrounding the bottom wall (21), and a connection wall (23) extending downwards from the bottom edge of the casing wall (22), there is a flange (24) surrounding the bottom surface of the bottom wall (21), there is a ring groove (25) between the flange (24) and the casing wall (22), and there is a drip part (26) in the center of the bottom wall (21) for dripping water, there is a second thread (27) surrounding the top outer wall of the casing wall (22), the inner wall of the connection wall (23) corresponds to the first thread (11), surrounded with a third thread (28) which can be screwed on the first thread (11), so that the drip container (2) can be screwed on the cup container (1); a cover body (3), at the top of the drip container (2), and the bottom inner wall of the cover body (3) corresponds to the second thread (27), surrounded with a fourth thread (31) which can be screwed on the second thread (27), so that the cover body (3) can be screwed on the drip container (2); and a filter container (4), located between the drip container (2) and the cup container (1), and the top edge of the filter container (4) is chucked in the ring groove (25) of the drip container (2), and the top outer wall of the filter container (4) is surrounded with a bearing rib (41) which can be gripped by the inner wall of the cup container (1), there is a filter screen (42) at the bottom of the filter container (4).

Said cup container (1) is screwed on the lower part of the drip container (2). The filter container (4) is located between the drip container (2) and the cup container (1). The cover body (3) is screwed on the upper part of drip container (2), and there is a drip part (26) in the drip container (2). Therefore, when the water is poured in the drip container (2), the water in the drip container (2) drips through the drip part (26) slowly into the pulverized coffee in the filter container (4). The pulverized coffee absorbs the water and swells, when it is saturated, it drips through the filter screen (42) at the bottom of the drip container (4) into the cup container (1), so as to implement dripping. The user loosens the cup container (1) from the bottom of the filter container (4) to drink coffee, it is very convenient.

Secondly, said cup container (1), drip container (2) and cover body (3) are assembled by threaded connection, so the tightness and firmness of the portable cup (100) are better than chucking of previous techniques, so as to avoid leak and structural disassembly when the cup is shaken by external force or tilted. In addition, it is convenient to be assembled and disassembled, the cup container (1), drip container (2) and cover body (3) can be loosened one by one, and then the structures are cleaned one by one to avoid stains.

In addition, the filter container (4) is located between drip container (2) and cup container (1), the filter container (4) can be removed and cleaned after the drip container (2) and cup container (1) are loosened and disassembled.

Said drip part (26) comprises a projection (261) in the center of the bottom wall (21); a ring wall (262) around the projection (261); a water holding space (263) between the ring wall (262) and the projection (261); a projecting part (264) on the top of the projection (261); a water inlet (265) through the center of the projecting part (264) for dripping the water from the water holding space (263) into the filter container (4); and a through hole (266) with narrow top and wide bottom which is connected to the bottom of the water inlet (265).

The water holding space (263) cooperates with the water in et (265) to control the flow and velocity of the water dripping from the drip container (2), to adjust the correct concentration mixing ratio of pulverized coffee and water effectively, so as to extract the most uniform coffee to enhance the coffee taste and quality.

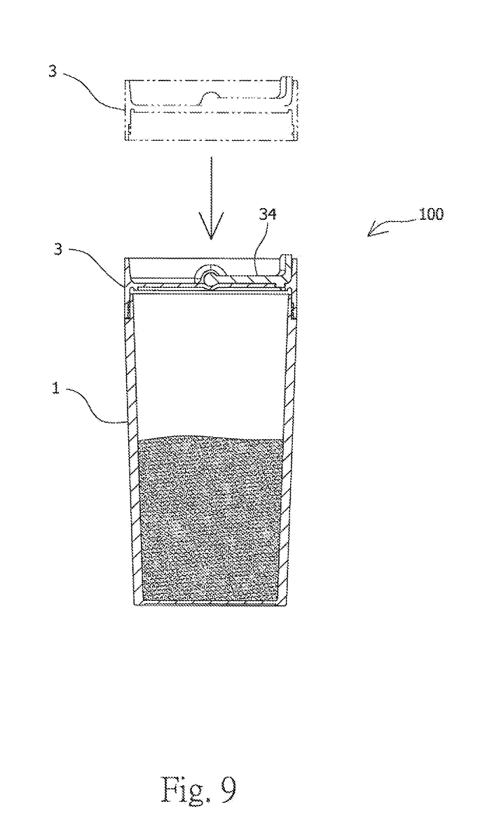

As shown in FIGS. 8 and 9, the fourth thread part (31) of said cover body (3) can be screwed on the first thread (11) of the cup container (1), so that the cover body (3) can be screwed on the cup container (1). Therefore, the cover body (3) can be loosened and removed from the drip container (2), and combined with the cup container (1). When there is some coffee left in the cup container (1), the cup container (1) can be sealed with the cover body (3) for thermal insulation and cold insulation, and the coffee will not overflow the cup container (1) when it is tilted.

Secondly, there is a concave annular groove (32) in the top of said cover body (3). There is a drainage hole (33) in the front of the annular groove (32), and there is a close over (34) in the annular groove (32) which can pivot to open or close the drainage hole (33). Therefore, when the user wants to drink the coffee in the cup container (1), the close over (34) is turned to expose the drainage hole (33). On the contrary, when the user does not drink the coffee, he turns the close over (34) to close the drainage hole (33). It is very convenient.

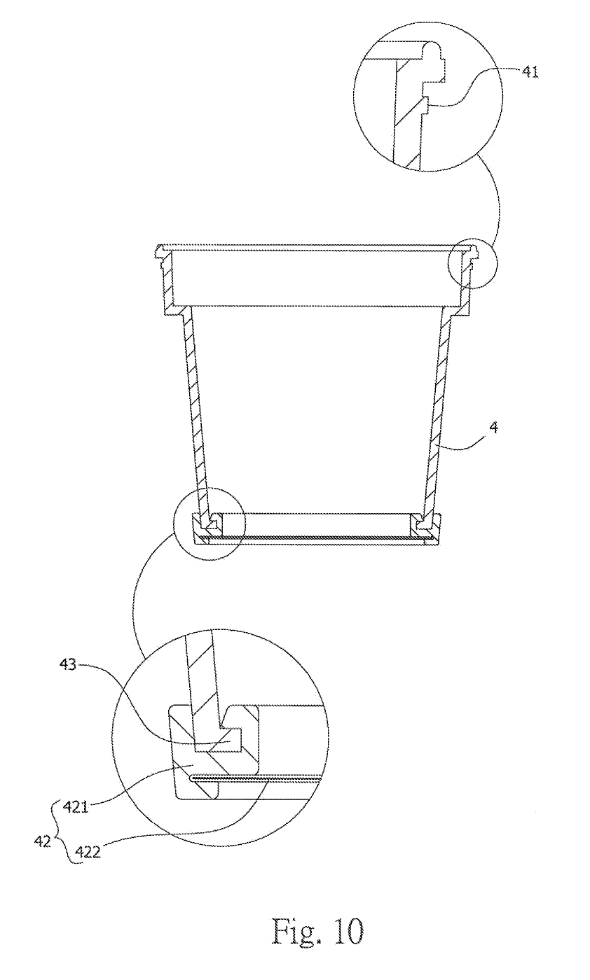

As shown in FIG. 10, there is a seizing part (43) in the inner wall of bottom edge of said filter container (4), the filter screen (42) comprises a silica gel cover (421) gripping the seizing part (43) and a screen (422) at the bottom of the silica gel cover (421). Therefore, the filter screen (42) and the seizing part (43) are combined by chucking, it is more convenient to clean and change the filter screen (42).

Although the invention has been explained in relation to its preferred embodiment, it is to be understood that many other possible modifications and variations can be made without departing from the spirit and scope of the invention as hereinafter claimed.

1. A drip portable cup, the portable cup (100) comprising:
a cup container (1) having the first thread (11) on top outer wall;
a drip container (2) disposed at a top of the cup container (1) and comprising a funnel-shaped bottom will (21), a casing wall (22) surrounding the bottom wall (21), a connection wall (23) extending downwards from the bottom edge of the casing wall (22), a plurality of flanges (24) surrounded at a bottom surface of the bottom wall (21), a ring groove (25) arranged between a flange (24) and the casing wall (22), a drip part (26) disposed in a center of the bottom wall (21) for dripping water, a second thread (27) surrounded in the top outer wall of the casing wall (22), and a third thread (28) arranged in the inner wall of the connection wall (23) corresponding to the first thread (11) and screwed on the first thread (11), so that the drip container (2) can be screwed on the cup container (1);
a cover body (3) disposed at a top of the drip container (2) and surrounded with fourth threads (31) arranged in the bottom inner wall of the cover body (3) corresponding to the second threads (27) capable of screwing on the fourth threads (31), so that the cover body (3) can be screwed on the drip container (2); and a filter container (4) disposed between the drip container (2) and the cup container (1); the top edge of the filter container (4) is clamped in the ring groove (25) of the drip container (2); the top outer wall of the filter container (4) is surrounded with a bearing rib (41) which can be gripped by the inner wall of the cup container (1); a filter screen (42) at the bottom of the filter container (4);
wherein the drip part (26) is composed of a projection (261) protruded from a top center of the bottom wall (21); a ring wall (262) around the projection (261); a water holding space (263) between the ring wall (262) and the projection (261); a projection part (264) protruded from a top of the projection (261); a water inlet (265) assign through the center of the projecting part (264) for dripping the water from the water holding space (263) into the filter container (4); and a through hold (266) with narrow top and wide bottom which is connected to the bottom of the water inlet (265).

2. (canceled)

3. The device defined in claim 1, wherein the top of the cover body (3) has a. concave annular groove (32), there is a drainage hole (33) in the front of the annular groove (32), and there is a close over (34) in the annular groove (32) which can pivot to open or dose the drainage hole (33).

4. The device defined in claim 1, wherein the fourth thread (31) of the cover body (3) can be screwed on the first thread (11) of the cup container (1), so that the cover body (3) can be screwed on he cup container (1).

5. The device defined in claim 1, wherein a seizing part (43) on the inner wall of the bottom edge of the filter container (4), the filter screen (42) comprises a silica gel cover (421) gripping the seizing part (43) and a screen (422) at the bottom of the silica gel cover (421).
